(19) United States
(12) Patent Application Publication
(10) Pub. No.: US 2023/0342651 A1
(43) Pub. Date: Oct. 26, 2023

(54) QUBIT LEAKAGE REMOVAL

(71) Applicant: Google LLC, Mountain View, CA (US)

(72) Inventors: Kevin Chenghao Miao, Goleta, CA (US); Alexander Korotkov, Riverside, CA (US); Matthew James McEwen, Santa Barbara, CA (US); Rami Barends, San Diego, CA (US); Juan Carlos Atalaya Chavez, Berkeley, CA (US)

(21) Appl. No.: 18/305,174

(22) Filed: Apr. 21, 2023

Related U.S. Application Data
(60) Provisional application No. 63/333,864, filed on Apr. 22, 2022.

(51) Int. Cl. G06N 10/70; G06N 10/40

(52) U.S. Cl. CPC G06N 10/70; G06N 10/40

(57) ABSTRACT

Methods, systems and apparatus for transporting data qubit leakage. In one aspect, an apparatus includes, for a data qubit that has been operated on by a quantum computing system to place the data qubit in a first state, wherein the first state encodes logical information: preparing, by the quantum computing system, an ancilla qubit in a known initial state; and performing, by the quantum computing system, a leakage transport operation using one or more two-qubit gates on the data qubit and the ancilla qubit to transfer leakage from the data qubit to the ancilla qubit.

### CROSS-REFERENCE TO RELATED APPLICATIONS

This application claims the benefit under 35 U.S.C. § 119(e) of U.S. Patent Application No. 63/333,864, filed Apr. 22, 2022. The disclosure of the foregoing application is incorporated herein by reference in its entirety for all purposes.

### BACKGROUND

This specification relates to quantum computing.

Classical computers have memories made up of bits, where each bit can represent either a zero or a one. Quantum computers maintain sequences of quantum bits, called qubits, where each quantum bit can represent a zero, one, or any quantum superposition of zero and one. Quantum computers operate by setting qubits in an initial state and controlling the qubits, e.g., according to a sequence of quantum computing operations such as single-qubit gates, entangling gates, and measurement. These quantum computing operations can cause the qubit to populate non-computational levels, creating a demand for a protocol that can remove leakage population from these non-computational levels without adversely impacting performance.

### SUMMARY

This specification describes technologies for removing leakage from a qubit.

In general, one innovative aspect of the subject matter described in this specification can be implemented in a method for transporting leakage in a quantum computing system, the method including: for a data qubit that has been operated on by a quantum computing system to place the data qubit in a first state, wherein the first state encodes logical information: preparing, by the quantum computing system, an ancilla qubit in a known initial state; and performing, by the quantum computing system, a leakage transport operation using one or more two-qubit gates on the data qubit and the ancilla qubit to transfer leakage from the data qubit to the ancilla qubit.

Other implementations of this aspect include corresponding classical or quantum computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the two-qubit gates comprise diabatic CZ gates.

In some implementations the data qubit comprises a low frequency qubit and the ancilla qubit comprises a high frequency qubit.

In some implementations the known initial state comprises a one-state.

In some implementations preparing the ancilla qubit in the known initial state comprises preparing the ancilla qubit in a zero-state; and applying a Pauli-X gate to the ancilla qubit.

In some implementations the one or more two-qubit gates comprise at least two two-qubit gates.

In some implementations applying the at least two two-qubit gates comprises, for each consecutive pair of two-qubit gates: performing a first two-qubit gate included in the pair of two-qubit gates; and after a predetermined delay time is reached, applying a second two-qubit gate included in the pair of two-qubit gates.

In some implementations the predetermined delay time is calibrated using one or more tunable parameters to increase a likelihood of successful leakage transport.

In some implementations the tunable parameters comprise one or more of delay time, CZ gate strength, or detuning between the data qubit and the ancilla qubit.

In some implementations the method further comprises performing, by the quantum computing system, a reset operation on the ancilla qubit.

In some implementations the method is performed i) in response to the quantum computing system completing a predetermined sequence of operations or ii) at regular intervals during a quantum computation.

In some implementations the predetermined sequence of operations comprises a set of stabilizer measurements.

In general, another innovative aspect of the subject matter described in this specification can be implemented in a method for transporting leakage from a first qubit to a second qubit, the method including determining a frequency distance that is calibrated for implementation of a two-qubit gate; tuning, by a quantum computing system, an operating frequency of the first qubit; tuning, by the quantum computing system, an operating frequency of the second qubit to an operating frequency that is the determined frequency distance from the operating frequency of the first qubit; determining a pulse that, when applied to a coupler that that couples the first qubit and the second qubit, causes a predetermined rotation of the first qubit and the second qubit, wherein the predetermined rotation is half a rotation required for implementation of a diabatic CZ gate; and applying, by the quantum computing system, the pulse to the coupler.

Other implementations of this aspect include corresponding classical or quantum computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations prior to applying the pulse to the coupler, the first qubit is in a quantum state with an uncorrectable leakage population and the second qubit is in a zero state.

In some implementations after applying the pulse to the coupler, the first qubit is in the quantum state with a correctable Pauli error and the second qubit is in a one state.

In some implementations the method further comprises correcting the Pauli error using quantum error correction.

In some implementations the first qubit comprises a data qubit that encodes logical information and the second qubit comprises an ancilla qubit.

In some implementations the first qubit comprises a high frequency qubit and the second qubit comprises a low frequency qubit.

In some implementations the method is performed i) in response to the quantum computing system completing a predetermined sequence of operations or ii) at regular intervals during a quantum computation.

In some implementations the predetermined sequence of operations comprises a round of quantum error correction operations.

In some implementations the method further comprises performing a reset operation on the second qubit.

The subject matter described in this specification can be implemented in particular ways so as to realize one or more of the following advantages.

A system implementing any of the techniques described in this specification can remove leakage states on a data qubit without resetting the data qubit and destroying the quantum information encoded in the state of the data qubit.

Accordingly, the presently described techniques are particularly suitable for fault tolerant quantum computing devices that implement quantum error correction (QEC). In such QEC applications, the presently described techniques can achieve large reductions in steady state leakage population P|2> (compared to applications of QEC that do not implement the presently described techniques), e.g., up to −10 times less steady state leakage population P|2>.

In addition, the presently described techniques can remove data qubit leakage with high efficiency, e.g., achieving |12>-to-|30> conversion rates of up to 95% (where |12> indicates |1> on the ancilla/measure qubit and |2> on the data qubit).

In addition, the presently described techniques can be implemented using existing hardware and control procedures, e.g., hardware and control procedures for implementing CZ gates. The techniques do not require additional hardware or architectural changes. However, the techniques can equally be implemented using different types of hardware and control procedures, e.g., those that might be available in the future. For example, the techniques are compatible with hardware with different device connectivities (number of other qubits each qubit can couple with), hardware with different types of couplings, or hardware that uses different types of qubits.

In addition, the presently described techniques can be implemented with a small cost in time. This is important since target computational states suffer from error with increased gate time.

In addition, the presently described techniques do not require additional hardware logic. Some alternative conventional methods require fast hardware to perform feedforward after detecting leakage states. Such requirements add even more complexity on top of an already difficult problem. These requirements and additional complexity are avoided using the presently described techniques.

Details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example system 100 for data qubit leakage removal.

FIG. 2A is a circuit diagram that shows a first example leakage pump gate.

FIG. 2B is a circuit diagram that shows a second example leakage pump gate.

FIG. 3A is a circuit diagram that shows an ideal action of the first example leakage pump gate in the absence of data qubit leakage.

FIG. 3B is a circuit diagram that shows an ideal action of the first example leakage pump gate in the presence of data qubit leakage.

FIG. 3C is a circuit diagram that shows an ideal action of the second example leakage pump gate in the presence of data qubit leakage.

FIG. 4 is a flow diagram of an example process for removing data qubit leakage using a leakage pump gate.

FIG. 5 is a plot that shows data qubit 2-state population with varying CZ-CZ delay times.

FIG. 6 shows a plot of data qubit leakage population at each step of a quantum error correction process without a leakage pump gate and a plot of data qubit leakage population at each step of a quantum error correction process with a leakage pump gate.

FIG. 7A is a circuit diagram of example operations performed on a data qubit and a measure qubit during a round of quantum error correction.

FIG. 7B is a circuit diagram of example operations performed on a data qubit and a measure qubit during a round of quantum error correction that includes the presently described leakage iSWAP gate.

FIG. 7C is a circuit diagram of example operations performed on a data qubit and a measure qubit during a round of quantum error correction that includes the presently described leakage iSWAP gate and measure qubit reset.

FIG. 8 is a flow diagram of an example process for leakage from a first qubit to a second qubit using a leakage iSWAP gate

FIG. 9 shows two illustrations of example frequency trajectories for a data qubit, measure qubit, and a coupler.

FIG. 10A is a flow diagram of an example process for calibrating a leakage iSWAP gate.

FIG. 10B is a plot that shows data qubit leakage population for varying coupling strengths and qubit resonance.

FIG. 11 shows two plots that compare quantum error correction errors during different numbers of quantum error correction rounds.

FIG. 12 shows a plot of data qubit leakage population at each step of a quantum error correction process with the presently described leakage iSWAP gate.

FIG. 13 depicts an example system for performing the classical and quantum computations described in this specification.

### DETAILED DESCRIPTION

In quantum computing operations are typically performed on qubits in the computational basis, e.g., between the zero- and one-excitation manifold. However, since physical qubits are not perfect two-level systems and there are higher energy levels corresponding to additional excitations, there is a probability of leaving the computational basis and entering those higher states. This process is referred to as leakage. Leakage can introduce errors into quantum computations. In particular, leakage is troublesome for quantum error correction as it can induce correlated errors, breaking a fundamental assumption of error correction.

Existing techniques remove leakage by resetting the qubit, however this also results in the destruction of the quantum information encoded in the computational basis. These techniques can improve quantum error correction performance since it can be applied to measure qubits, which only encode temporary information at each round and can be reset. However, this is incompatible with data qubits in quantum error correction since data qubits must maintain the encoded state at all times.

This specification describes two approaches for solving this problem. Each approach selectively swaps leakage states on a data qubit into a respective ancilla qubit, while keeping the data qubit's computational basis undisturbed. Once that is achieved, the ancilla qubit can be reset, removing the unwanted excitations in the system. The leakage in the data qubit then appear as an error in the computational basis, which can be readily corrected through error correction protocols.

A first approach leverages leakage transport, which is intrinsic to the two-qubit entangling gates that are used to perform quantum computations. Leakage transport converts the leakage state |2> on a data qubit into a higher leakage state |3> on a respective ancilla qubit, which then can be reset. The two-qubit gate's effect on the computational basis of the data qubit is deterministic and can be inverted if required. The leakage transport process is highly efficient, resulting in |2>-to-|3> conversion rates of up to 95%.

A second approach is based on a new quantum gate, which is referred to herein as a Leakage-iSWAP gate. The Leakage-iSWAP gate is based on a modification of a two-qubit gate and is executed such that a unidirectional conversion of the leakage state |2> on a data qubit into a |1> state on a respective ancillary qubit is achieved. Executions of this gate result in very high |2>-to-|1> conversion rates exceeding 99%. Furthermore, resetting |1> on the ancillary qubit can be accomplished much more easily than higher leakage states such as |3>, making this protocol particularly appealing.

### Example Operating Environment

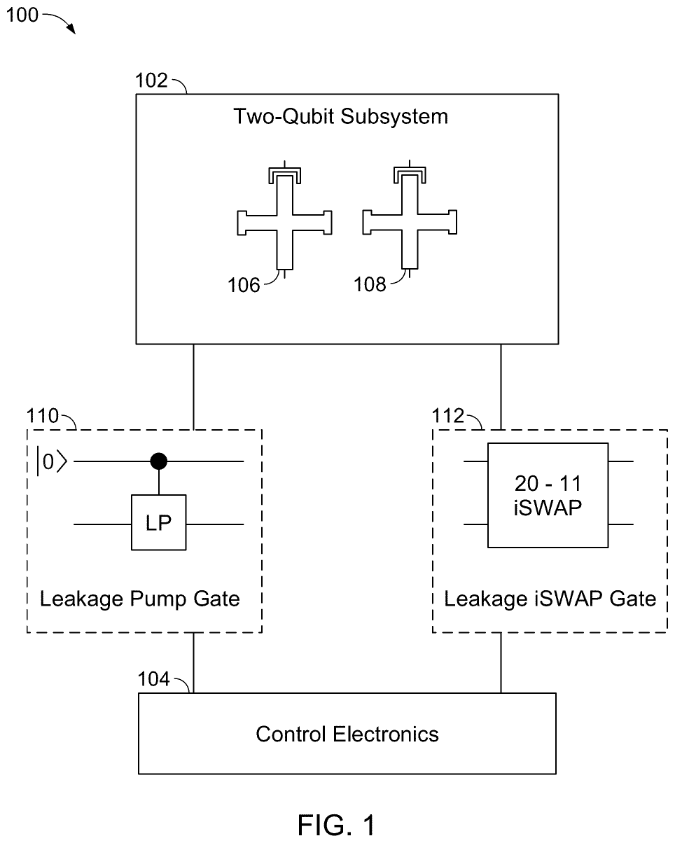

FIG. 1 depicts an example system 100 for data qubit leakage removal. The example system 100 is an example of a system implemented as part of a quantum computing device in which the systems, components and techniques described in this specification can be implemented.

The system 100 includes a two-qubit subsystem 102 in communication with control electronics 104. The two-qubit subsystem 102 includes a first qubit 106 coupled to a second qubit 108. In some implementations the first qubit 106 can be a data qubit. A data qubit is a qubit that participates in quantum computations performed by the system 100 and stores quantum information corresponding to the quantum computations. That is, the state of the data qubit encodes logical information for a quantum computation. In some implementations the second qubit 108 is an ancilla qubit (also referred to herein as a measure qubit). A measure qubit is a qubit that is used to determine an outcome of a computation performed by the data qubit. For example, during a computation an unknown state of the data qubit can be entangled with the state of the measurement qubit using a suitable physical operation, after which the measure qubit can be measured.

The first qubit 106 and the second qubit 108 can each be in a respective quantum state that occupies one or more levels. The levels include two computational levels, e.g., levels 0- and 1-, and one or more non-computational levels that are each higher in energy (or equivalently, higher in frequency) than the computational qubit levels, e.g., levels 2- and 3-. Population of the higher, non-computational qubit levels can introduce errors in algorithmic operations or quantum computations performed using the qubit. For example, the occupation of qubit levels outside the computational subspace can hamper or prevent the implementation of quantum error correction operations.

The first qubit 106 can be coupled to second qubit 108 via a coupler. The coupler can, in principle, be any type of coupler, e.g., a capacitive or inductive coupler. The coupler that couples the first qubit 106 to the second qubit 108 is controllable. For example, the strength of the coupler can be frequency controllable.

In some implementations the first qubit 106 and second qubit 108 can be superconducting qubits or semiconducting qubits. For example, the first qubit 106 and second qubit 108 can be part of a linear chain of capacitively coupled Xmon qubits included in a quantum computing device. However, in other cases the qubits can include flux qubits, phase qubits, or qubits with frequency interactions. In general, a qubit may be any physical system with multiple energy levels that comprise a two-level computational sub-space and a non-computational subspace of at least one energy level.

The first qubit 106 and second qubit 108 can be operated by adjusting the qubit frequencies, e.g., applying pulses generated by the control electronics 104 to the qubits. In cases where the first qubit 106 and the second qubit 108 are Xmon qubits, the qubit frequencies can be parked at a predetermined distance from one another, and in a zig-zag position with respect to other qubits that can be included in the quantum computing device.

The control electronics 104 include control devices, e.g., arbitrary waveform generators, that can operate the first qubit 106 and second qubit 108. For example, the control electronics 104 can include control devices that tune the operating frequency of the first qubit 106 and second qubit 108 by applying control signals, e.g., voltage pulses, to the qubits through respective control lines. The control electronics 104 can also include control devices that tune a frequency of the coupler that couples the first qubit 106 and the second qubit 108.

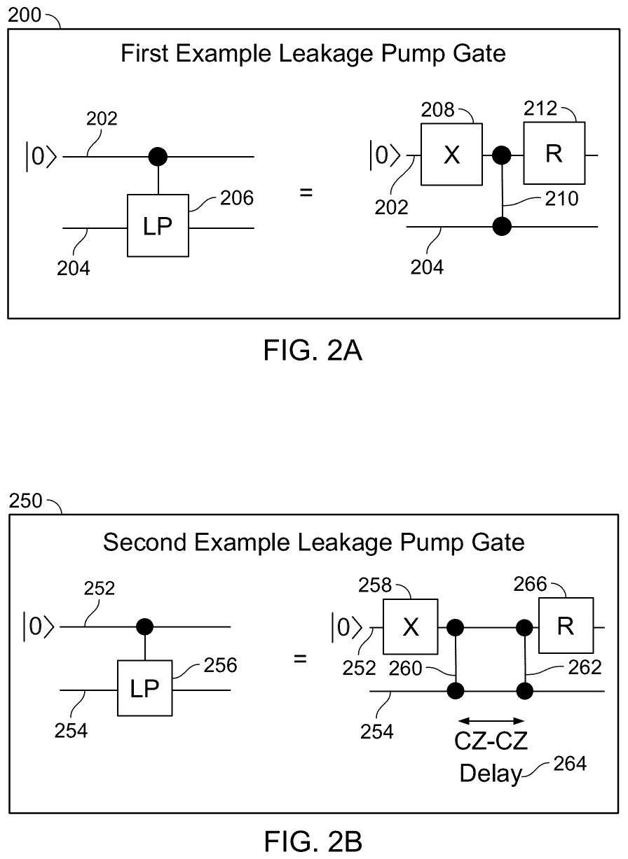

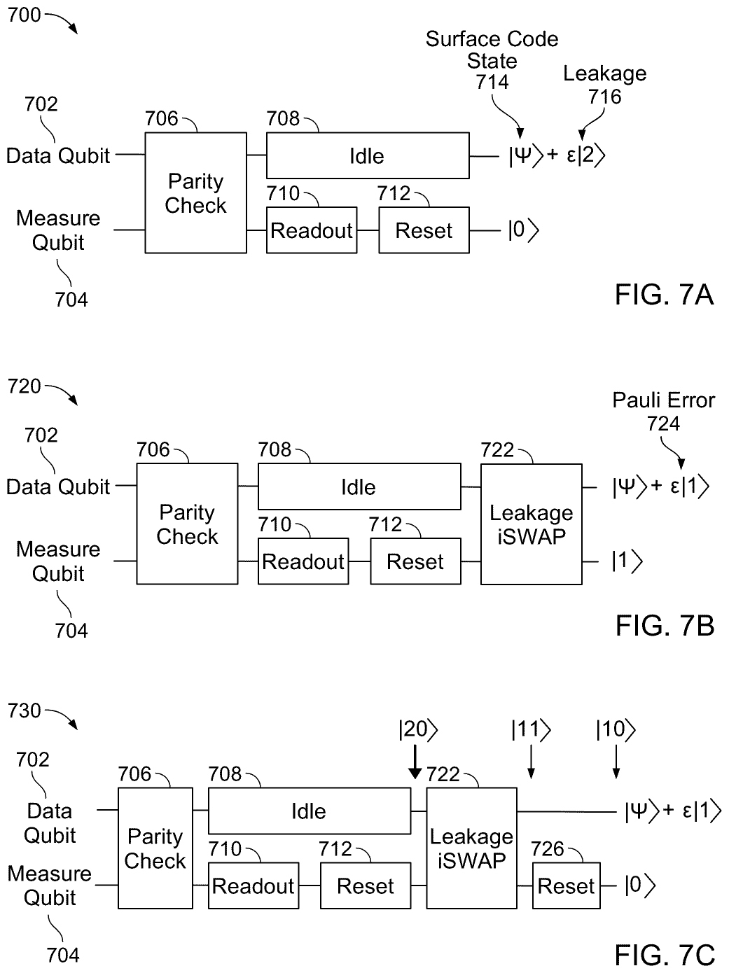

The system 100 can program the control electronics 104 to selectively transport leakage from the first qubit 106 to the second qubit 108, while keeping the first qubit's 106 computational basis undisturbed. For example, the system 100 can program the control electronics 104 to apply a leakage pump gate 110 to the first qubit 106 and second qubit 108. Example leakage pump gates are described in more detail below with reference to FIGS. 2-6. As another example, the system 100 can program the control electronics 104 to apply a leakage iSWAP gate 112 to the first qubit 106 and second qubit 108. Example leakage iSWAP gates are described in more detail below with reference to FIGS. 7-12.

### Programming the Hardware: Leakage Pump Via Leakage Transport

FIG. 2A is a circuit diagram that shows a first example leakage pump gate 200. An ancilla qubit 202 is prepared in an initial state, e.g., a 0-state. A data qubit 204 is in some quantum state that encodes logical information. Ideally, the data qubit 204 is in a quantum state that is a superposition of computational states 0- and 1-, i.e., a quantum state in the computational basis. However, in some implementations the data qubit 204 can be in a quantum state that has leaked into non-computational states, e.g., 2-, 3-, etc.

A leakage pump gate 206 is applied to the ancilla qubit 202 and the data qubit 204. Application of the leakage pump gate 206 transfers leakage from the data qubit 204 to the ancilla qubit 202. The leakage pump gate 206 can be decomposed into the sequence of quantum gates shown in the right hand side of FIG. 2A. That is, the leakage pump gate 206 includes a Pauli-X gate 208 that is applied to the ancilla qubit 202 and a CZ gate that is applied to the ancilla qubit 202 and the data qubit 204. In some implementation the CZ gate can be a diabatic CZ gate. Diabatic CZ gates can be used because diabatic CZ gates use interactions with higher states, and these interactions can be used to perform the presently described protocol. Adiabatic gates are designed not to interact with or populate higher states, although they can do so anyway due to non-idealities or competing performance concerns. The action of a CZ gate on quantum states in the computational basis is symmetric and is given in the table below:

| Input \|a [symbol] \|b [symbol] | Output \|a [symbol] \|b [symbol] |
|---|---|
| \|0 [symbol] \|0 [symbol] | \|0 [symbol] \|0 [symbol] |
| \|0 [symbol] \|1 [symbol] | \|0 [symbol] \|1 [symbol] |
| \|1 [symbol] \|0 [symbol] | \|1 [symbol] \|0 [symbol] |
| \|1 [symbol] \|1 [symbol] | −\|1 [symbol] \|1 [symbol] |

However, the action of a CZ gate on leakage states is asymmetric and one qubit (e.g., a higher frequency qubit) receives leakage from the other qubit:

| Input \|a [symbol] \|b [symbol] | Output \|a [symbol] \|b [symbol] |
|---|---|
| \|1 [symbol] \|2 [symbol] | \|3 [symbol] \|0 [symbol] |
| \|2 [symbol] \|2 [symbol] | \|3 [symbol] \|1 [symbol] |

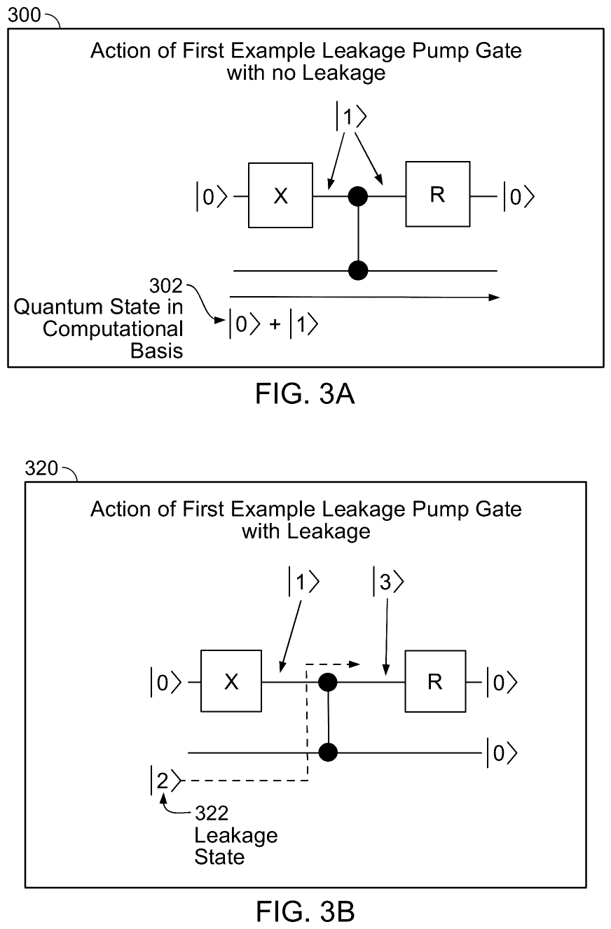

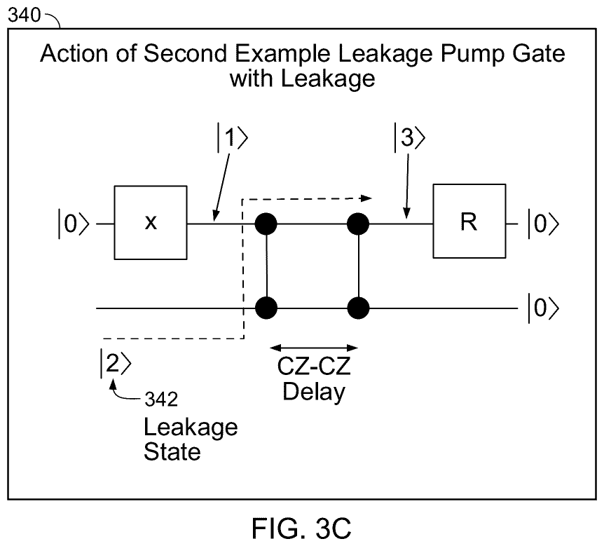

Application of the Pauli-X gate 208 and the CZ gate 210 therefore transfers leakage from the data qubit 204 to the ancilla qubit 202, as shown in FIGS. 3A and 3B. After the leakage has been transferred, a reset operation 212 can be performed on the ancilla qubit 202 to remove the transferred leakage and put the ancilla qubit in the 0-state.

In some implementations a Z gate can be applied to the qubit 204 after the CZ gate 210 has been applied. Application of a Z gate to the qubit 204 acts as a correction and ensures that the computational state of the qubit 204 remains the same.

FIG. 2B is a circuit diagram that shows a second example leakage pump gate 250. An ancilla qubit 252 is prepared in an initial state, e.g., a 0-state. A data qubit 254 is in some quantum state that encodes logical information. Ideally, the data qubit 254 is in a quantum state that is a superposition of computational states 0- and 1-, i.e., a quantum state in the computational basis. However, in some implementations the data qubit 254 can be in a quantum state that has leaked into non-computational states, e.g., 2-, 3-, etc.

A leakage pump gate 256 is applied to the ancilla qubit 252 and the data qubit 254. Application of the leakage pump gate 256 transfers leakage from the data qubit 254 to the ancilla qubit 252. The leakage pump gate 256 can be decomposed into the sequence of quantum gates shown in the right hand side of FIG. 2B. That is, the leakage pump gate 256 includes a Pauli-X gate 208 that is applied to the ancilla qubit 252 and multiple CZ gates 260, 262 that are applied to the ancilla qubit 252 and the data qubit 254. In some implementations the multiple CZ gates 260, 262 can be diabatic CZ gates. Application of the Pauli-X gate 258 and the CZ gates 260, 262 transfers leakage from the data qubit 254 to the ancilla qubit 252, as shown in FIG. 3C.

The second CZ gate 262 is not applied immediately after the first CZ gate 260 is applied. Instead, application of the first CZ gate 260 and the second CZ gate 262 is separated by a CZ-CZ delay time 264. The delay time can enable constructive interference between the transport of the first and second CZ gates, enhancing overall leakage transport. The delay time 264 can be calibrated to optimize the action of the leakage pump gate 256, e.g., improve the percentage of leakage that is successfully pumped from the data qubit state to the ancilla qubit, as described below with reference to FIG. 5.

In some implementations an alternative to adjusting the delay time between CZ gates can be implemented. For example, one (or both) qubit frequencies can be shifted by a controlled manner to induce a phase shift. This strategy can produce the same highly effective leakage pump action.

After the leakage has been transferred, a reset operation 266 can be performed on the ancilla qubit 252 to remove the transferred leakage and put the ancilla qubit in the 0-state. In some implementations the second example leakage pump gate 250 can be more effective than the first example leakage pump gate 200, e.g., the second example leakage pump gate 250 can successfully pump a higher percentage of leakage from the data qubit state to the ancilla qubit compared to the first example leakage pump gate 200. This is because slight shifts in qubit frequency allow the constructive interference between two gates to be tuned. However, the second example leakage pump gate 250 requires the implementation of more quantum gates and a longer execution time, which increases the computational costs associated with executing the second example leakage pump gate 250. Therefore, in some implementations it can be more advantageous to implement the first example leakage pump gate 200. It is not necessary to apply a Z gate to the data qubit in this example, since application of multiple CZ gates can more accurately transport leakage such that no corrections are needed.

FIG. 3A is a circuit diagram 300 that shows an ideal action of the first example leakage pump gate in the absence of data qubit leakage. As described above with reference to FIG. 2A, an ancilla qubit is prepared in a 0-state and a data qubit is in a quantum state 302 that is in the computational basis, i.e., a quantum state without leakage. After a Pauli X gate is applied to the ancilla qubit the ancilla qubit is in a 1-state. After a CZ gate is applied to the ancilla qubit and the data qubit the ancilla qubit remains in the 1-state and the quantum state of the data qubit remains in the computational basis. After a reset operation is applied to the ancilla qubit the ancilla qubit returns to the 0-state. In some implementations a Z gate can be applied to the data qubit after the CZ gate has been applied. Application of a Z gate to the data qubit acts as a correction and can ensure that the computational state of the data qubit remains the same.

FIG. 3B is a circuit diagram 320 that shows an ideal action of the first example leakage pump gate in the presence of data qubit leakage. In this example, an ancilla qubit is prepared in a 0-state and a data qubit is in a quantum state 322 that has leaked outside of the computational basis into a 2-state, i.e., the quantum state with leakage. After a Pauli X gate is applied to the ancilla qubit the ancilla qubit is in a 1-state. After a CZ gate is applied to the ancilla qubit and the data qubit, the leakage is transported from the data qubit to the ancilla qubit so that the ancilla qubit is in a 3-state. The data qubit is then in a 0-state. After a reset operation is applied to the ancilla qubit the ancilla qubit returns to the 0-state. In some implementations a Z gate can be applied to the data qubit after the CZ gate has been applied. Application of a Z gate to the data qubit acts as a correction and can ensure that the computational state of the data qubit remains the same.

FIG. 3C is a circuit diagram 340 that shows an ideal action of the second example leakage pump gate in the presence of data qubit leakage. In this example, an ancilla qubit is prepared in a 0-state and a data qubit is in a quantum state 342 that has leaked outside of the computational basis into a 2-state, i.e., the quantum state with leakage. After a Pauli X gate is applied to the ancilla qubit the ancilla qubit is in a 1-state. After multiple CZ gates are applied to the ancilla qubit and the data qubit, the leakage is transported from the data qubit to the ancilla qubit so that the ancilla qubit is in a 3-state. The data qubit is then in a 0-state. After a reset operation is applied to the ancilla qubit the ancilla qubit returns to the 0-state. It is not necessary to apply a Z gate to the data qubit in this example, since application of multiple CZ gates can more accurately transport leakage such that no corrections are needed.

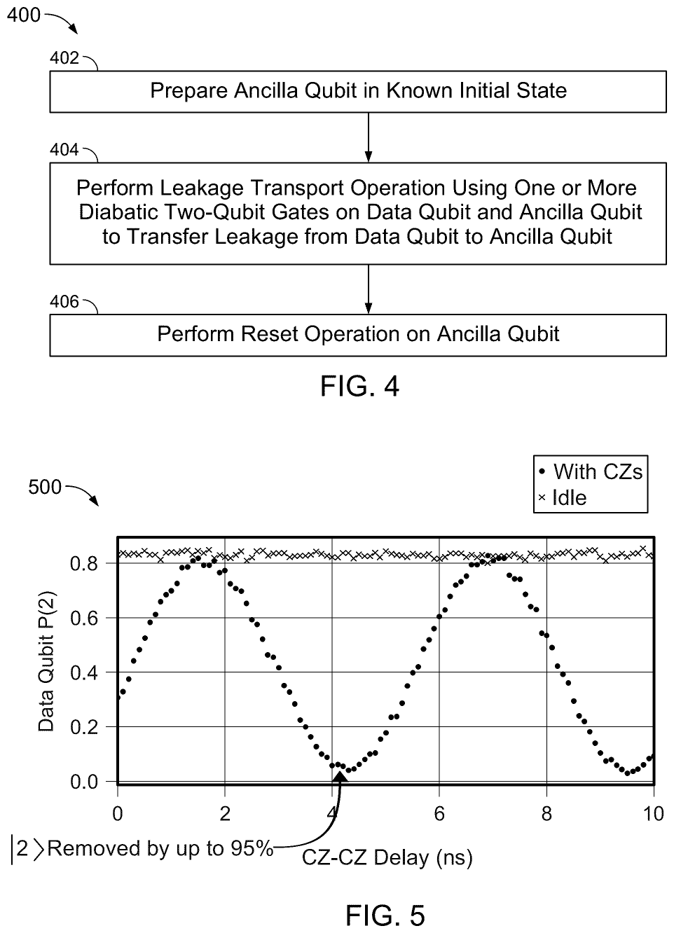

FIG. 4 is a flow diagram of an example process 400 for removing data qubit leakage using a leakage pump gate. For convenience, the process 400 will be described as being performed by quantum hardware in communication with control electronics located in one or more locations. For example, the quantum computing system 100 of FIG. 1, appropriately programmed in accordance with this specification, can perform the process 400.

For a data qubit that has been operated on by the quantum computing system to place the data qubit in a first state, where the first state encodes logical information, the system prepares an ancilla qubit in a known initial state (step 402). For example, the system can initialize the ancilla qubit in a 0-state, e.g., by performing a reset operation, and apply a Pauli-X gate to the ancilla qubit to place the ancilla qubit in a 1-state.

The system performs a leakage transport operation using one or more two-qubit gates on the data qubit and the ancilla qubit to transfer leakage from the data qubit to the ancilla qubit (step 404). In some implementations the one or more two-qubit gates are CZ gates. The CZ gates can be diabatic CZ gates. In implementations where the system applies multiple two-qubit gates, e.g., two or more, the system can apply the two-qubit gates with a predetermined delay time between each consecutive two-qubit gate. For example, for each consecutive pair of two-qubit gates the system can perform the first two-qubit gate included in the pair and after a predetermined delay time is reached, apply the second two-qubit gate included in the pair.

The delay time can be calibrated in advance using one or more tunable parameters to increase a likelihood of successful leakage transport. For example, for each of multiple calibration experiments with a fixed number of two-qubit gates, the system can perform steps 402 and 404 for respective values of one or more tunable parameters and measure the data qubit to obtain measurement results that represent a remaining data qubit 2-population. The system can then use the measurement results to identify values of the one or more tunable parameters that produce optimal leakage removal, e.g., achieve a lowest remaining 2-population. Example tunable parameters include delay time, CZ gate strength, or detuning between the data qubit and the ancilla qubit.

FIG. 5 is a plot 500 that shows data qubit 2-state population with varying CZ-CZ delay times. Plot 500 shows that a delay time of approximately 4.4 ns between CZ gates produces optimal leakage removal, e.g., up to 95% leakage removal. Other parameters could be used instead of or in addition to delay time. For example, in implementations where operating frequencies of the data qubit and ancilla qubit can be adjusted, the system can vary the detuning of one of the qubits between application of the two-qubit gates, e.g., with a fixed delay time, to identify a detuning frequency that produces optimal leakage removal.

Returning to FIG. 4, in some implementations, after the leakage has been transferred from the data qubit to the ancilla qubit, the system can perform a reset operation on the ancilla qubit to remove the transferred leakage (step 406).

In some implementations example process 600 can be performed when the system completes a predetermined sequence of operations during a quantum computation, e.g., a sequence of operations that puts the ancilla qubit in a known state. For example, in quantum error correction example process 600 can be performed when the system completes a set of stabilizer measurements since after a set of stabilizer measurements the ancilla qubit (measure qubit) is measured and reset, which puts the ancilla qubit in a known initial state as described at step 402 above. In other implementations example process can be performed at regular time intervals during a quantum computation.

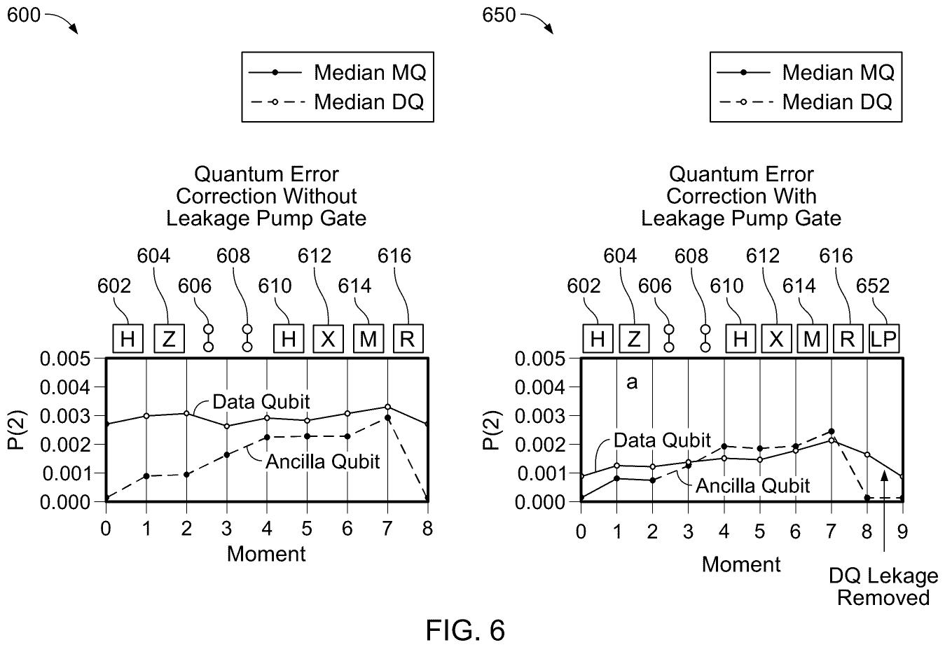

FIG. 6 shows two plots of data qubit leakage population at each step of a quantum error correction process. Plot 600 shows data qubit leakage population at each step of a quantum error correction process without the presently described leakage pump gate. The x-axis represents steps or moments of the quantum error correction process. The steps are shown above plot 600 and include: application of a Hadamard gate 602 to an ancilla qubit, application of a Pauli-Z gate 604 to the ancilla qubit, application of two CZ gates 606, 608 to the ancilla qubit and the data qubit, application of a Hadamard gate 610 to an ancilla qubit, application of a Pauli-X gate 612 to the data qubit, measurement 614 of the ancilla qubit and resetting 616 of the ancilla qubit. As shown, during the quantum error correction process the data qubit leakage population is stable and remains between approximately 0.0025 and 0.0035. The ancilla qubit leakage population increases slowly and steadily, until the ancilla qubit reset.

Plot 650 shows data qubit leakage population at each step of a quantum error correction process with the presently described leakage pump gate. The x-axis represents steps or moments of the quantum error correction process. The steps are shown above plot 650 and are the same as those shown in plot 600, with the exception that a leakage pump gate 652 is also applied to the data qubit and ancilla qubit after the reset operation 616 is applied to the ancilla qubit. As shown, during the quantum error correction process the data qubit leakage population is also stable and remains between approximately 0.0095 and 0.002—approximately two times lower than that shown in plot 600.

Programming the Hardware: Leakage Reset Via Leakage iSWAP Gate

Another approach for removing leakage from a data qubit is based on a new quantum gate that selectively transfers a leaked state, e.g., the state 20, to a correctable quantum state, e.g., the state 11 (where 20 represents a 2-state on the data qubit and a 0-state on the ancilla/measure qubit). This gate is referred to herein as a leakage iSWAP gate and is described below. The leakage iSWAP gate is particularly suitable for implementing during a round of quantum error correction and is primarily described in this setting, however this is a non-limiting example and the leakage iSWAP gate can be applied in other settings, e.g., any setting where it is beneficial to selective swap a leaked state from one qubit to another.

FIG. 7A is a circuit diagram 700 of example operations performed on a data qubit and a measure qubit during a round of quantum error correction. Parity check operations 706 are performed on the data qubit 702 and the measure qubit 704 to diagnose correctable errors in the state of the data qubit. After the parity check operations 706, the data qubit idles 708 and the state of the measure qubit is readout 710 to obtain results of the parity check operations 706. The measure qubit is then reset 712.

After the quantum error correction operations, the measure qubit 704 is in a 0-state and the data qubit 702 is in a quantum state that corresponds to the quantum computation being performed by the quantum computer. Ideally, the quantum state will be a surface code state 714 in the computational basis. However, in some cases the quantum state can include some leakage population, e.g., leakage 716. The leakage 716 can occur during the quantum computation or during the round of error correction.

FIG. 7B is a circuit diagram 720 of example operations performed on a data qubit and a measure qubit during a round of quantum error correction that includes the presently described leakage iSWAP gate. As described above with reference to FIG. 7A, parity check operations 706 are performed on the data qubit 702 and the measure qubit 704 to diagnose correctable errors in the state of the data qubit. After the parity check operations 706, the data qubit idles 708 and the state of the measure qubit is readout 710 to obtain results of the parity check operations 706. The measure qubit is then reset 712.

The presently described leakage iSWAP gate 722 is applied to the data qubit 702 and the measure qubit 704. Application of the leakage iSWAP gate 722 removes the leakage population 716 of the data qubit 702 by selectively transporting the leakage population 716 to the measure qubit 704. Therefore, after the quantum error correction operations 706, 708, 710, 712, and 722 the measure qubit 704 is in a 1-state and the data qubit 702 is in a quantum state that includes the surface code state 714 and a correctable Pauli error 724. That is, application of the leakage iSWAP gate 722 rotates the state |20> to |11> without affecting the surface code state 714. Unlike the leakage population |2>, the remaining correctable Pauli error 724 ∈|1> can be effectively corrected by quantum error correction.

FIG. 7C is a circuit diagram 730 of example operations performed on a data qubit and a measure qubit during a round of quantum error correction that includes the presently described leakage iSWAP gate and measure qubit reset. As described above with reference to FIG. 7B, parity check operations 706 are performed on the data qubit 702 and the measure qubit 704 to diagnose correctable errors in the state of the data qubit. After the parity check operations 706, the data qubit idles 708 and the state of the measure qubit is readout 710 to obtain results of the parity check operations 706. The measure qubit is then reset 712 and a leakage iSWAP gate 722 is applied to the data qubit 702 and the measure qubit 704. A second reset operation 726 is applied to the measure qubit 704 to place the measure qubit in a 0-state.

After the quantum error correction operations 706, 708, 710, 712 have been performed the data qubit includes 2-state leakage population and the measure qubit is in a 0-state. After the leakage iSWAP gate 722 has been performed the data qubit includes a 1-state Pauli error and the measure qubit is in a 1-state. After the second reset operation 726 the data qubit includes a 1-state Pauli error and the measure qubit is in a 0-state.

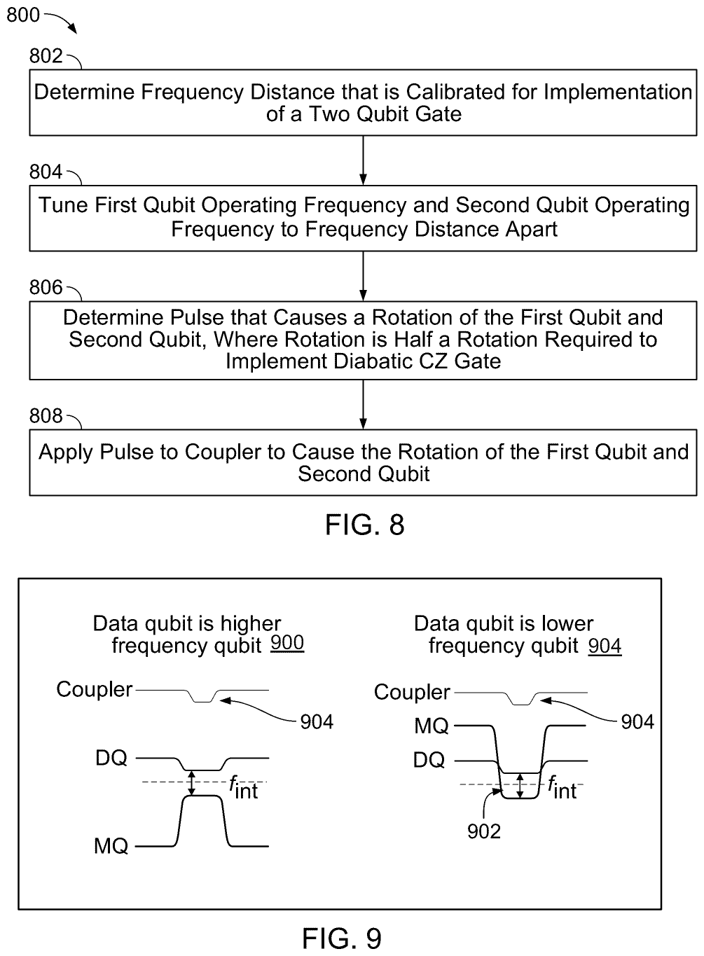

FIG. 8 is a flow diagram of an example process 800 for leakage from a first qubit to a second qubit using a leakage iSWAP gate. In example process 800, the first qubit can be a data qubit that encodes logical information, and the second qubit can be an ancilla qubit (measure qubit). For convenience, the process 800 will be described as being performed by quantum hardware in communication with control electronics located in one or more locations. For example, the quantum computing system 100 of FIG. 1, appropriately programmed in accordance with this specification, can perform the process 800.

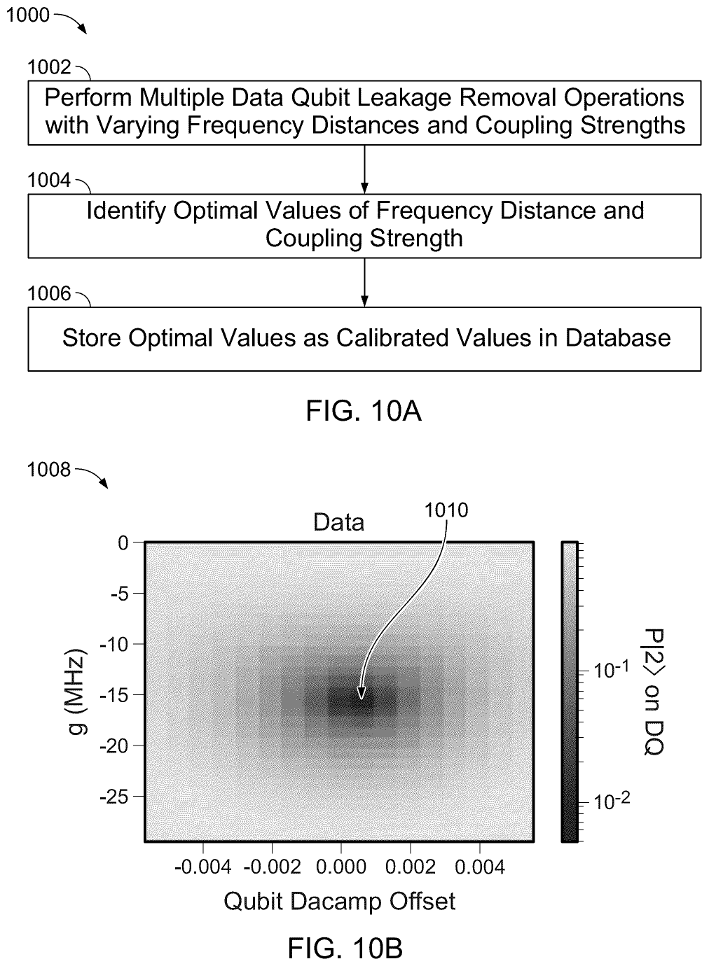

The system determines a frequency distance that is calibrated for implementation of a two-qubit gate (step 802). As shown below with reference to FIG. 9, In some implementations the frequency distance can represent a frequency distance between an operating frequency of the first qubit and an operating frequency of the second qubit, where the operating frequency of the first qubit is set with respect to an interaction frequency and the operating frequency of the second qubit is set with respect to the operating frequency of the first qubit. In some implementations the system can retrieve data representing the frequency distance from a database that stores recently calibrated values for frequency distances, pulse strengths, etc. In other implementations the system can perform multiple experiments to determine the calibrated frequency distance, as described in more detail below with reference to FIGS. 10A and 10B.

The system tunes an operating frequency of the first qubit and an operating frequency of the second qubit to an operating frequency that is the determined frequency distance from the operating frequency of the first qubit (step 804).

The system determines a pulse that, when applied to a coupler that couples the first qubit and the second qubit, causes a rotation of the first qubit and the second qubit (step 806). The rotation is half a rotation required for implementation of a diabatic CZ gate. Application of pulse that is calibrated for a CZ gate causes a two-qubit 11-state to rotate to a 20-state and then back to the 11-state (with a conditional phase). Therefore, the pulse determined by the system at step 806 can be viewed as half a pulse required to implement a CZ gate, since then the two-qubit 11-state rotates to a 20-state (and does not rotate back to the 11-state). The determined pulse is similar to the pulse required for execution of a CZ gate but is defined by different parameter values. Example pulse shapes are shown in FIG. 9. In terms of parameters, (and for frequency tunable couplers), the pulse can be defined as a pulse that moves qubits to an appropriate frequency distance from each other, then brings the coupler down in frequency toward the qubits in a trapezoidal pulse shape. The primary parameters can include the length and depth of this trapezoidal pulse—these tune the amount of and strength of interaction respectively. These parameters can be adjusted to efficiently transport leakage.

In some implementations the system may primarily use CZ gates as a two-qubit for performing quantum computations, and so already have the hardware and routines in place for performing CZ gates. The same hardware and routines (with different parameter values) can be used to determine and apply the pulse for data qubit leakage removal, which can reduce the hardware complexity and control complexity required to perform data qubit leakage removal.

In some implementations the system can retrieve data representing the pulse from a database that stores recently calibrated values for frequency distances, pulse strengths, etc. In other implementations the system can perform multiple experiments to calibrate the pulse, as described in more detail below with reference to FIGS. 10A and 10B

The system applies the pulse to the coupler (step 808). Prior to applying the pulse to the coupler, the first qubit can be in a quantum state with an uncorrectable leakage population and the second qubit can be in a zero state. Application of the pulse causes selective transportation of the leakage population from the data qubit to the measure qubit, as described above with reference to FIGS. 7B and 7C. Therefore, after the pulse is applied to the coupler the first qubit is in the quantum state with a correctable Pauli error and the second qubit is in a one state.

In some implementations the system can correct the Pauli error using quantum error correction. Alternatively or in addition, the system can perform a reset operation on the second qubit.

In some implementations example process 800 can be performed when the system completes a predetermined sequence of operations during a quantum computation, e.g., when the system completes a round of quantum error correction operations. In other implementations example process can be performed at regular time intervals during a quantum computation.

FIG. 9 shows two illustrations of example frequency trajectories for a data qubit, measure qubit, and coupler during example process 800. In the first illustration 900 the data qubit is the higher frequency qubit (compared to the measure qubit). The operating frequency of the data qubit and measure qubit are tuned such that the operating frequencies are a predetermined distance 902 apart (about an interaction frequency fᵢₙₜ). For example, the operating frequency of the data qubit can first be tuned with respect to the interaction frequency and the operating frequency of the measure qubit can then be tuned with respect to the operating frequency of the data qubit to place the operating frequencies of the data qubit and measure qubit the correct distance apart.

The coupler is pulsed 904 to cause the data qubit and measure qubit to interact. The pulse is calibrated to cause a rotation of the data qubit and the measure qubit, where the rotation is half a rotation required for implementation of a diabatic CZ gate.

In the second illustration 906 the data qubit is the lower frequency qubit (compared to the measure qubit). As in plot 900, the operating frequency of the data qubit and measure qubit are tuned such that the operating frequencies are a predetermined distance 902 apart (about the interaction frequency fᵢₙₜ). Because the data qubit is the lower frequency qubit in this illustration, tuning the operating frequency of the measure qubit with respect to the data qubit causes the frequency of the measure qubit to cross the frequency of the data qubit. Therefore, in some implementations it can be more advantageous to set the data qubit as the higher interacting qubit.

The coupler is pulsed 904 to cause the data qubit and measure qubit to interact. The pulse is calibrated to cause a rotation of the data qubit and the measure qubit, where the rotation is half a rotation required for implementation of a diabatic CZ gate.

FIG. 10A is a flow diagram of an example process 1000 for calibrating a leakage iSWAP gate. For convenience, the process 1000 will be described as being performed by quantum hardware in communication with control electronics located in one or more locations. For example, the system 100 of FIG. 1, appropriately programmed in accordance with this specification, can perform the process 1000.

The system performs multiple data qubit leakage removal operations (step 1002). Each data qubit leakage removal operation can be performed using example process 1000 described above, where each data qubit leakage removal operation corresponds to respective values of the distance between the data qubit operating frequency and the measure qubit operating frequency and qubit coupling strength. FIG. 10B is a plot 1008 that shows data qubit leakage population for varying coupling strengths and qubit resonance. The x axis represents a tunable resonance condition that can be adjusted to vary the frequency distance between the operating frequency of the data qubit and the measure qubit. The y axis represents strength of the coupling between the data qubit and the measure qubit. Each pixel in the plot shows data qubit leakage population for an implementation of a leakage iSWAP gate using corresponding values of the coupling strength and qubit resonance. In this example, the lowest data qubit leakage population are represented by darker shaded areas, e.g., region 1010.

Returning to FIG. 10A, the system identifies an optimal value of the coupling strength and an optimal value of the frequency distance based on data qubit leakage population corresponding to the data qubit leakage removal operations (step 1004). For example, the system identifies a coupling strength value and a frequency distance that produce a lowest data qubit leakage population. In FIG. 10B, the lowest data qubit leakage population is produced by a coupling strength of approximately −16 MHz and a frequency distance of approximately 0.8 Volts. In FIG. 10B, the “dacamp offset” is an offset from the naive frequency distance, which is assumed to be one nonlinearity apart (e.g., approximately 270 MHz in this example). The frequency distance can be fine-tuned by adjusting the dacamp offset, which allows the gate to be adjusted on the single MHz level.

The system stores the optimal value of the coupling strength and an optimal value of the frequency distance as calibrated values for implementing a leakage iSWAP gate in a suitable database (step 1006).

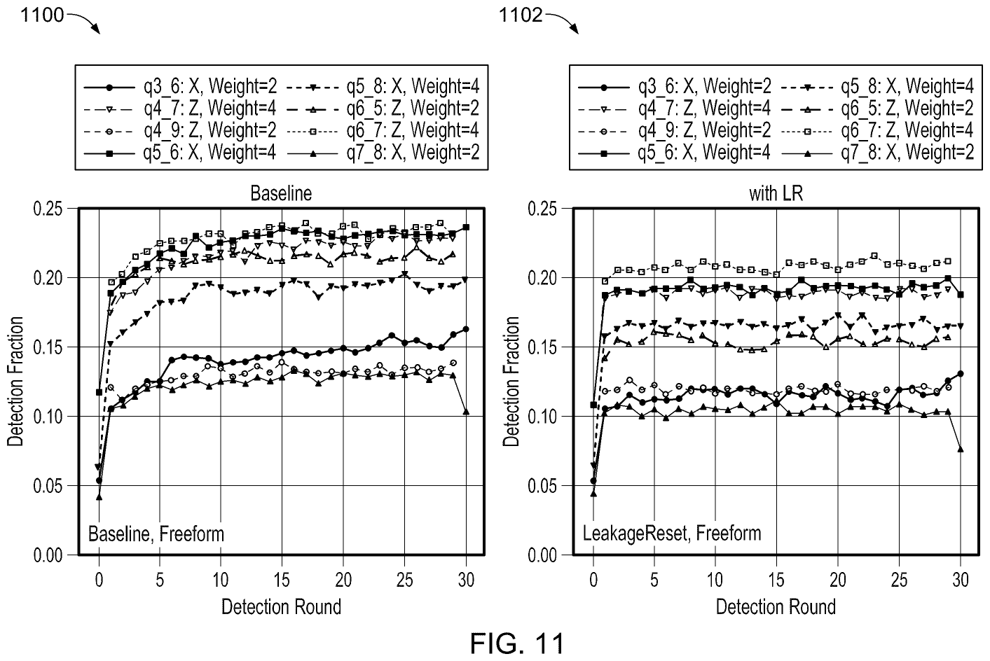

FIG. 11 shows two plots 1100, 1102 that compare quantum error correction errors during different numbers of quantum error correction rounds. Plot 1100 shows quantum error correction errors during different numbers of quantum error correction rounds without the presently described leakage iSWAP gate. The y axis of plot 1100 represents detection fractions, i.e., a proportion of stabilizer measurements that indicate that there was an error. The x axis of plot 1100 represents individual rounds of quantum error correction. The different lines represent respective measure qubits in the error correction code and the markers (open/filled, circles/squares) represent the responsibility of each measure qubit, e.g., squares indicate that the measure qubit has 4 data qubit neighbors, circles indicate 2 data qubit neighbors, open markers indicate measuring Z errors, while filled markers indicate measuring X errors. The increase in detection fractions for each line (which increases quickly between 0 and 10 rounds then stabilizes or gradually increases between 10 and 30 rounds) is indicative of leakage.

Plot 1102 shows quantum error correction errors during different numbers of quantum error correction rounds with the presently described leakage iSWAP and reset gate (e.g., the procedure described by FIG. 7C). Again, the y axis of plot 1102 represents detection fractions and the x axis of plot 1102 represents individual rounds of quantum error correction. Plot 1102 shows that implementing the presently described leakage iSWAP gate prevents the slow increase of detections fractions shown in plot 1100. In addition, the amount of detection fraction is low and remains stable after the first round of error correction, indicating that the quantum error correction is not disturbed by the addition of the leakage iSWAP gate.

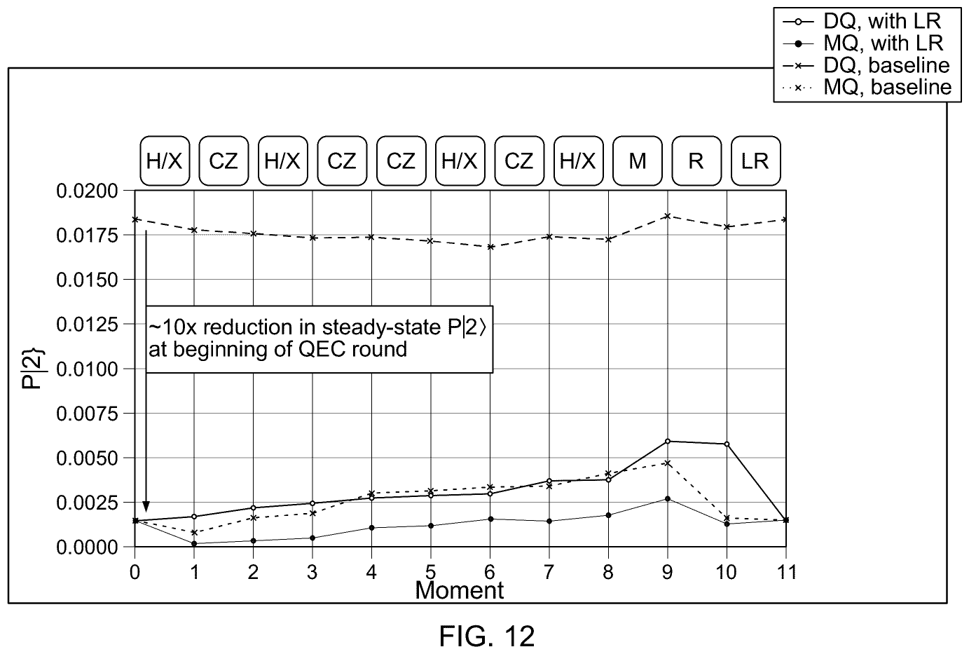

FIG. 12 shows a plot 1200 of data qubit leakage population at each step of a quantum error correction process with the presently described leakage iSWAP gate. The x-axis represents steps or moments of the quantum error correction process. The steps are shown at the top of the plot 1200 and include: parity check operations 1202 applied to the data qubit and ancilla qubit, measurement 1204 of the ancilla qubit, resetting 1206 of the ancilla qubit, and application of the leakage iSWAP gate 1208 to the data qubit and the ancilla qubit. In FIG. 12, data corresponding to the dashed lines replace the leakage removal moment with an equivalent wait time where the qubits are inactive. These dotted lines are included to improve the ease of analysis/comparison.

As shown, the presently described techniques achieve a large reduction in steady state P|2> at the beginning of a QEC round. The reduction at the beginning of the QEC round is particularly interesting because the presence of leakage is arguably most damaging at the beginning of a QEC round, where many CZs are executed. Each CZ has the potential to transport and enhance the leakage between the two qubits it acts on. By starting with low leakage at the beginning of the round, the possibility of this undesired expansion of leakage is minimized.

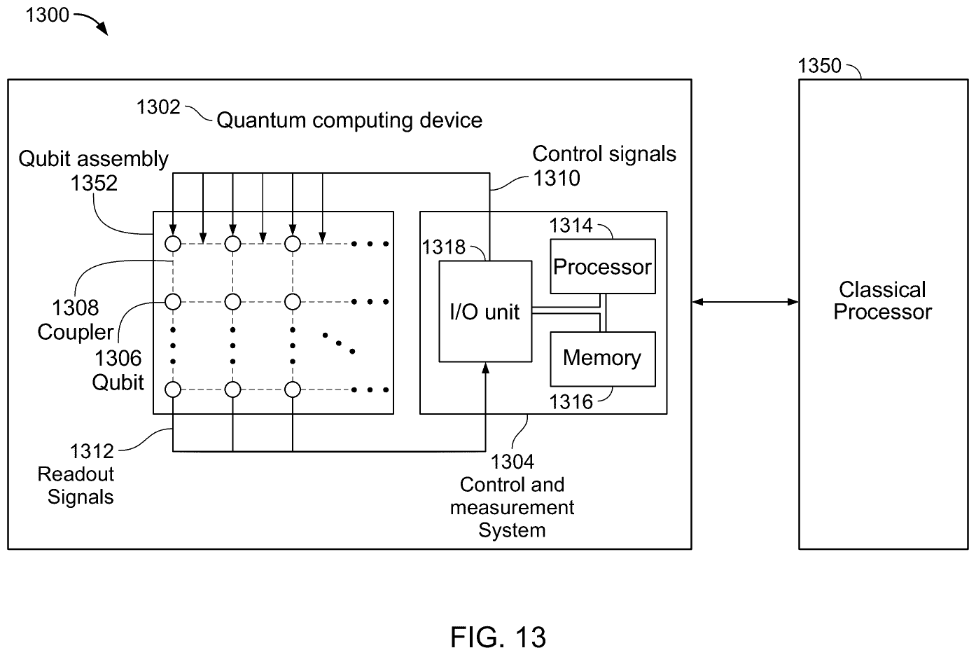

FIG. 13 depicts an example system 1300 for performing the classical and quantum computations described in this specification. The example system 1300 is an example of a system implemented as classical and quantum computer programs on one or more classical computers and quantum computing devices in one or more locations, in which the systems, components, and techniques described herein can be implemented.

The example system 1300 includes an example quantum computing device 1302. The quantum computing device 1302 can be used to perform the quantum computation operations described in this specification according to some implementations. The quantum computing device 1302 is intended to represent various forms of quantum computing devices. The components shown here, their connections and relationships, and their functions, are exemplary only, and do not limit implementations of the inventions described and/or claimed in this document.

The example quantum computing device 1302 includes a qubit assembly 1352 and a control and measurement system 1304. The qubit assembly includes multiple qubits, e.g., qubit 1306, that are used to perform algorithmic operations or quantum computations. While the qubits shown in FIG. 13 are arranged in a rectangular array, this is a schematic depiction and is not intended to be limiting. The qubit assembly 1352 also includes adjustable coupling elements, e.g., coupler 1308, that allow for interactions between coupled qubits. In the schematic depiction of FIG. 13, each qubit is adjustably coupled to each of its four adjacent qubits by means of respective coupling elements. However, this is an example arrangement of qubits and couplers, and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device included in example system 1300 or the type of quantum computations that the quantum computing device is performing. For example, in an atomic quantum computer the qubits can be realized via atomic, molecular or solid-state quantum systems, e.g., hyperfine atomic states. As another example, in a superconducting quantum computer the qubits can be realized via superconducting qubits or semi-conducting qubits, e.g., superconducting transmon states. As another example, in a NMR quantum computer the qubits can be realized via nuclear spin states.

In some implementations a quantum computation can proceed by initializing the qubits in a selected initial state and applying a sequence of unitary operators on the qubits. Applying a unitary operator to a quantum state can include applying a corresponding sequence of quantum logic gates to the qubits. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), and gates involving three or more qubits, e.g., Toffoli gates. The quantum logic gates can be implemented by applying control signals 1310 generated by the control and measurement system 1304 to the qubits and to the couplers.

For example, in some implementations the qubits in the qubit assembly 1352 can be frequency tuneable. In these examples, each qubit can have associated operating frequencies that can be adjusted through application of voltage pulses via one or more drive-lines coupled to the qubit. Example operating frequencies include qubit idling frequencies, qubit holding frequencies, qubit interaction frequencies, and qubit readout frequencies. Different frequencies correspond to different operations that the qubit can perform. For example, setting the operating frequency to a corresponding idling frequency can put the qubit into a state where it does not strongly interact with other qubits, and where it can be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tuneable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions can be performed in order to perform multi-qubit gates.

The type of control signals 1310 used depends on the physical realizations of the qubits. For example, the control signals can include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 1310. The measurements cause readout signals 1312 representing measurement results to be communicated back to the measurement and control system 1304. The readout signals 1312 can include RF, microwave, or optical signals depending on the physical scheme for the quantum computing device and/or the qubits. For convenience, the control signals 1310 and readout signals 1312 shown in FIG. 13 are depicted as addressing only selected elements of the qubit assembly (i.e., the top and bottom rows), but during operation the control signals 1310 and readout signals 1312 can address each element in the qubit assembly 1352.

The control and measurement system 1304 is an example of a classical computer system that can be used to perform various operations on the qubit assembly 1352, as described above, as well as other classical subroutines or computations. The control and measurement system 1304 includes one or more classical processors, e.g., classical processor 1314, one or more memories, e.g., memory 1316, and one or more I/O units, e.g., I/O unit 1318, connected by one or more data buses. The control and measurement system 1304 can be programmed to send sequences of control signals 1310 to the qubit assembly, e.g., to carry out a selected series of quantum gate operations, and to receive sequences of readout signals 1312 from the qubit assembly, e.g., as part of performing measurement operations.

The processor 1314 is configured to process instructions for execution within the control and measurement system 1304. In some implementations, the processor 1314 is a single-threaded processor. In other implementations, the processor 1314 is a multi-threaded processor. The processor 1314 is capable of processing instructions stored in the memory 1316.

The memory 1316 stores information within the control and measurement system 1304. In some implementations, the memory 1316 includes a computer-readable medium, a volatile memory unit, and/or a non-volatile memory unit. In some cases, the memory 1316 can include storage devices capable of providing mass storage for the system 1304, e.g., a hard disk device, an optical disk device, a storage device that is shared over a network by multiple computing devices (e.g., a cloud storage device), and/or some other large capacity storage device.

The input/output device 1318 provides input/output operations for the control and measurement system 1304. The input/output device 1318 can include D/A converters, A/D converters, and RF/microwave/optical signal generators, transmitters, and receivers, whereby to send control signals 1310 to and receive readout signals 1312 from the qubit assembly, as appropriate for the physical scheme for the quantum computer. In some implementations, the input/output device 1318 can also include one or more network interface devices, e.g., an Ethernet card, a serial communication device, e.g., an RS-232 port, and/or a wireless interface device, e.g., an 802.11 card. In some implementations, the input/output device 1318 can include driver devices configured to receive input data and send output data to other external devices, e.g., keyboard, printer, and display devices.

Although an example control and measurement system 1304 has been depicted in FIG. 13, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The example system 1300 includes an example classical processor 1350. The classical processor 1350 can be used to perform classical computation operations described in this specification according to some implementations, e.g., the classical machine learning methods described herein.

Implementations of the digital and/or quantum subject matter and the digital functional operations and quantum operations described in this specification can be implemented in digital electronic circuitry, suitable quantum circuitry or, more generally, quantum computational systems, in tangibly-embodied digital and/or quantum computer software or firmware, in digital and/or quantum computer hardware, including the structures disclosed in this specification and their structural equivalents, or in combinations of one or more of them. The term “quantum computational systems” can include, but is not limited to, quantum computers, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits, or a combination of one or more of them. Alternatively or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that can be suitably approximated as a two-level system in the corresponding context. Such quantum systems can include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which can also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which can also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A digital and/or quantum computer program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that can transmit quantum data using quantum systems, e.g. qubits. Generally, a digital data communication network cannot transmit quantum data, however a quantum data communication network can transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers to be “configured to” perform particular operations or actions means that the system has installed on its software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer can receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum processors or both, or any other kind of central digital and/or quantum processing unit. Generally, a central digital and/or quantum processing unit will receive instructions and digital and/or quantum data from a read-only memory, a random access memory, or quantum systems suitable for transmitting quantum data, e.g. photons, or combinations thereof.

The essential elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more non-transitory machine-readable storage media, and that are executable on one or more digital and/or quantum processing devices. The systems described in this specification, or portions of them, can each be implemented as an apparatus, method, or system that can include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for transporting leakage in a quantum computing system, the method comprising:
for a data qubit that has been operated on by a quantum computing system to place the data qubit in a first state, wherein the first state encodes logical information:
preparing, by the quantum computing system, an ancilla qubit in a known initial state; and
performing, by the quantum computing system, a leakage transport operation using one or more two-qubit gates on the data qubit and the ancilla qubit to transfer leakage from the data qubit to the ancilla qubit.

2. The method of claim 1, wherein the two-qubit gates comprise diabatic CZ gates.

3. The method of claim 1, wherein the data qubit comprises a low frequency qubit and the ancilla qubit comprises a high frequency qubit.

4. The method of claim 1, wherein the known initial state comprises a one-state.

5. The method of claim 4, wherein preparing the ancilla qubit in the known initial state comprises:
preparing the ancilla qubit in a zero-state; and
applying a Pauli-X gate to the ancilla qubit.

6. The method of claim 1, wherein the one or more two-qubit gates comprise at least two two-qubit gates.

7. The method of claim 6, wherein applying the at least two two-qubit gates comprises, for each consecutive pair of two-qubit gates:
performing a first two-qubit gate included in the pair of two-qubit gates; and
after a predetermined delay time is reached, applying a second two-qubit gate included in the pair of two-qubit gates.

8. The method of claim 7, wherein the predetermined delay time is calibrated using one or more tunable parameters to increase a likelihood of successful leakage transport.

9. The method of claim 8, wherein the tunable parameters comprise one or more of delay time, CZ gate strength, or detuning between the data qubit and the ancilla qubit.

10. The method of claim 1, further comprising performing, by the quantum computing system, a reset operation on the ancilla qubit.

11. The method of claim 1, wherein the method is performed i) in response to the quantum computing system completing a predetermined sequence of operations or ii) at regular intervals during a quantum computation.

12. The method of claim 11, wherein the predetermined sequence of operations comprises a set of stabilizer measurements.

13. An apparatus comprising:
one or more classical processors; and
quantum computing hardware in data communication with the one or more classical processors,
wherein the apparatus is configured to perform operations comprising:
for a data qubit that has been operated on by a quantum computing system to place the data qubit in a first state, wherein the first state encodes logical information:
preparing, by the quantum computing system, an ancilla qubit in a known initial state; and
performing, by the quantum computing system, a leakage transport operation using one or more two-qubit gates on the data qubit and the ancilla qubit to transfer leakage from the data qubit to the ancilla qubit.

14. A method for transporting leakage from a first qubit to a second qubit, the method comprising:
determining a frequency distance that is calibrated for implementation of a two-qubit gate;
tuning, by a quantum computing system, an operating frequency of the first qubit;
tuning, by the quantum computing system, an operating frequency of the second qubit to an operating frequency that is the determined frequency distance from the operating frequency of the first qubit;
determining a pulse that, when applied to a coupler that that couples the first qubit and the second qubit, causes a predetermined rotation of the first qubit and the second qubit, wherein the predetermined rotation is half a rotation required for implementation of a diabatic CZ gate; and
applying, by the quantum computing system, the pulse to the coupler.

15. The method of claim 14, wherein prior to applying the pulse to the coupler, the first qubit is in a quantum state with an uncorrectable leakage population and the second qubit is in a zero state.

16. The method of claim 15, wherein after applying the pulse to the coupler, the first qubit is in the quantum state with a correctable Pauli error and the second qubit is in a one state.

17. The method of claim 16, further comprising correcting the Pauli error using quantum error correction.

18. The method of claim 14, wherein the first qubit comprises a data qubit that encodes logical information and the second qubit comprises an ancilla qubit.

19. The method of claim 14, wherein the first qubit comprises a high frequency qubit and the second qubit comprises a low frequency qubit.

20. The method of claim 14, wherein the method is performed i) in response to the quantum computing system completing a predetermined sequence of operations or ii) at regular intervals during a quantum computation.

21. The method of claim 20, wherein the predetermined sequence of operations comprises a round of quantum error correction operations.

22. The method of claim 14, further comprising performing a reset operation on the second qubit.

23. An apparatus comprising:
one or more classical processors; and
quantum computing hardware in data communication with the one or more classical processors,
wherein the apparatus is configured to perform operations comprising:
determining a frequency distance that is calibrated for implementation of a two-qubit gate;
tuning, by a quantum computing system, an operating frequency of the first qubit;
tuning, by the quantum computing system, an operating frequency of the second qubit to an operating frequency that is the determined frequency distance from the operating frequency of the first qubit;
determining a pulse that, when applied to a coupler that that couples the first qubit and the second qubit, causes a predetermined rotation of the first qubit and the second qubit, wherein the predetermined rotation is half a rotation required for implementation of a diabatic CZ gate; and
applying, by the quantum computing system, the pulse to the coupler.
